(19) United States
(12) Patent Application Publication
(10) Pub. No.: US 2004/0147258 A1
(43) Pub. Date: Jul. 29, 2004

(54) Call pick-up system and method in a mobile communication network

(75) Inventor: Seh Joon Dokko, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/626,580

(22) Filed: Jul. 25, 2003

(30) Foreign Application Priority Data
Aug. 21, 2002 (KR) 10-2002-0049410
Oct. 4, 2002 (KR) 10-2002-0060681

(51) Int. Cl. H04Q 7/20

(52) U.S. Cl. 455/428; 455/424; 455/433

(57) ABSTRACT

A system and method in a mobile communication network allows a call directed to a first mobile terminal to be picked up and answered by a second mobile terminal, which may or may not be located nearby. The system includes a call processor that manages ringing information for the call to the first mobile phone, receives a call pick-up request from the second mobile phone, and then automatically or conditionally transfers the call to the second mobile phone. A visitor location register transmits subscriber information to the call processor which may be used as a condition for transferring the call. This system therefore allows a second mobile phone user, who hears the first phone ringing, to pick-up the call when the user of the first mobile phone is not available, when the first mobile phone battery is low or spent, or under other conditions.

### BACKGROUND OF THE INVENTION

1. Field of the Invention

The present invention relates to processing calls, and more particularly to a system and method for performing a call pick-operation in a mobile communication network.

2. Background of the Related Art

In the related art, a switching system detects a terminating signal from a caller (originating subscriber), connects the communication line to the intended receiver of the terminating signal to enable communication between the caller and the receiver, and disconnects the communication line when the communication is terminated so that the communication line may become available for a next communication.

The switching system also provides special services other than the above-described communication service. For example, a private switching system used for a factory or an office may provide a call forwarding service, call pick-up service, etc., through which terminating calls directed to certain phones may be transferred to other phones, enabling communication to take place through such other phones.

In the call forwarding service, a subscriber selects the call forwarding function in advance and registers such selection in the switching system (private switching system). Then, a terminating call arriving at the subscriber's phone is forwarded to the pre-registered call forwarding number for communication. In order to use this service, a subscriber must call the switching system to select or cancel the call forwarding service.

In the call pick-up service, a terminating call arriving at a certain subscriber's phone is picked up and connected to another phone for communication through the latter phone. This service may be performed without the subscriber selecting or registering the call forwarding function in advance. Unlike the call forwarding service, the call pick-up service is useful only for circumstances where the ringing signal may be heard. Nonetheless, because the call pick-up service may be available without any separate registration procedure to be conducted by subscribers, this service is often used in limited space where a private switching system is operated, such as in an office within a building.

As the number of mobile communication service users increases, mobile phones will become essential in daily life, i.e., many people will depend on mobile phones for communication at work and in daily life. Accordingly, mobile communication networks have begun providing their mobile phone subscribers with various services. However, until now, of the above-described services, only the call forwarding service has been provided. The call pick-up service has not yet been made available.

Thus, a subscriber in an area where he or she can hear a ringing signal of a terminating call of another mobile phone (e.g., in an office), i.e., a subscriber located within the coverage of the base station or sector, could not pick up such terminating call with his or her own mobile phone. In other words, in order to answer a call of another mobile phone, a subscriber had to move to the place where the ringing mobile phone is and had to answer through such mobile phone only. Especially in the communication service on the mobile communication network, if a terminating call is not answered within a specific time after the ringing signal has been generated, the terminating call is disconnected unless the call forwarding service has been registered for the mobile phone. Thus, subscribers must carry mobile phones all the time or select the call forwarding service in advance.

In a limited space such as a house or an office, most subscribers do not carry their mobile phones all the time when they move around within that limited space. Further, sometimes subscribers intentionally abstain from carrying their mobile phones when the circumstances are such that they cannot answer the phone. In such cases where subscribers cannot answer terminating calls because they did not carry their mobile phones and left them at certain positions, other people who detect that there are terminating calls arriving at such mobile phones must move to the positions where the mobile phones are located to answer them instead.

Moreover, because the call pick-up service is not supported in the mobile communication network of the related art, if a subscriber cannot continue communication because the battery for his or her mobile phone is not sufficiently charged or if a subscriber cannot find or reach his or her mobile phone while there is ringing signal for a terminating call, answering the phone itself has been difficult.

### SUMMARY OF THE INVENTION

An object of the invention is to solve one or more of the above problems and/or disadvantages and to provide at least one of the advantages described hereinafter.

Another object of the present invention is to provide a communications network which provides subscribers with a call pick-up service.

Another object of the present invention is to provide a system and method for registering and managing in common memories terminating ringing information of mobile phones called by terminating processes in a mobile communication network, thereby enabling the terminating call at one mobile phone to be picked up by another nearby mobile phone such as one within the coverage area of the same base station or sector as the first mobile phone.

Another object of the present invention is to provide a system and method which enables a terminating call of one mobile phone to be answered by another mobile phone even if the mobile phone being called is out of battery, is not located where there is ringing for the terminating call, or is located too far away to be reached.

Another object of the present invention is to provide a system and method which allows groups of subscribers to be designated for picking up terminating calls for other subscribers, and thus to enable a terminating call of one mobile phone to be picked up only by other mobile phone subscribers within the same group to thereby prevent privacy infringement which may be caused by unchecked picking up of calls.

Another object of the present invention to display on a mobile phone receiving a terminating call the number of another mobile phone which issued a request to pick up the terminating call, to thereby give the absent subscriber notice of who picked up the terminating call.

Another object of the present invention to register in a separate terminating information database terminating ringing information including a number, location, and terminating PID of a mobile phone which received a terminating call for another mobile phone in a mobile communication network. The present invention may also manage such information according to relevant group codes to thereby enable a terminating call of a mobile phone to be picked up for communication by another mobile phone within the area where the terminating call ringing signal may be heard, regardless of whether such area is within the coverage of the same base station or the same sector.

Another object of the present invention to classify subscribers who can pick up terminating calls of other subscribers into groups and manage the area where ringing signals may be heard in an adjacent base station list database DB, thus allowing only subscribers within the same group to pick up terminating calls for each other and to exclude terminating calls arriving at places out of the audible area from calls that may be picked up, for the purpose of providing an efficient call pick-up service.

In order to achieve these and other objects and advantages, the present invention provides a call pick-up system in a mobile communication network comprising: an originating call processor that transmits terminating information including the group code of the subscriber at the originating side and switching information; a terminating call processor that registers and manages terminating ringing information about mobile phones currently being called in terminating information memories and, if there is a call pick-up request, connects the terminating call which may be picked up to the mobile phone which requested the pick-up; a visitor location register that stores and manages subscriber information including subscriber group codes and mobile phone's location information and transmits to the terminating call processor the subscriber information about the subscriber who requested a pick-up including the subscriber's group code and location information; and a base station controller that controls the assignment of wireless traffic channels in response to a mobile phone's call request by conducting the base station control and the wireless resource management, and controls the communication line connection or disconnection.

The terminating call processor comprises: a terminating ringing process that registers and manages the terminating ringing information about the mobile phone currently being called in the terminating information memory and transmits the originating PID and switch information corresponding to the terminating call for which the pick-up request has been made; and a terminating pick-up process that, if digits indicating a call pick-up request are inputted, searches the terminating information memory and thus sends a call pick-up request to the terminating ringing process designated by the terminating PID, which is processing the terminating call for which the pick-up request has been made, and receives from the terminating ringing process the originating PID and switch information for the terminating call for which the pick-up request has been made and then notifies the originating process designated by the originating PID of the response to the terminating call.

The terminating ringing process terminates the terminating call after receiving from the terminating pick-up process the number of the mobile phone which requested the call pick-up and displaying the number through the base station controller on the mobile phone for which the terminating call is to be picked up, and deletes the terminating ringing information which has been registered and managed in the terminating information memory. The terminating pick-up process, after receiving from the visitor location register the information of the subscriber who requested the call pick-up, searches the terminating information memory by using the location information and group code included in said subscriber information and, as a result, obtains the terminating PID of the terminating ringing process which is processing the terminating call for the mobile phone which is to be picked up.

The mobile phone for which the terminating call may be picked up is a mobile phone located within the coverage of the same base station or sector and having the same group code as the subscriber who made the pick-up request.

The terminating information memory stores the terminating ringing information including the numbers of mobile phones currently being called by the relevant terminating processes, location information represented by base station ID and/or sector ID, and terminating PID, together with the pick-up group code, according to the relevant base station or sector.

Alternatively, the present invention provides a call pick-up system in a mobile communication network comprising: an originating call processor that transmits terminating information including the group code of the subscriber at the originating side and switching information; an adjacent base station list DB that, for each base station and/or sector, stores IDs of adjacent base stations and/or sectors belonging to the audible area where the ringing signal of a mobile phone currently being called in the relevant base station and/or sector may be heard; a terminating information DB that stores the terminating ringing information of mobile phones currently being called and sequence numbers of mobile phones for the time sequential search according to the pick-up group code; a terminating call processor that searches the adjacent base station list DB and the terminating information DB by using the pick-up group code and location information of the subscriber who requested the call pick-up and connects the terminating call which is to be picked up to the mobile phone which requested the pick-up; a visitor location register that stores and manages subscriber information including subscriber group codes and mobile phone's location information and transmits to the terminating call processor the subscriber information about the subscriber who requested the pick-up including the subscriber's group code and location information; and a base station controller that controls the assignment of wireless traffic channels in response to a mobile phone's call request by conducting the base station control and the wireless resource management, and controls the communication line connection or disconnection.

The terminating call processor comprises: a terminating ringing process that registers and manages the terminating ringing information about mobile phones currently being called in the terminating information DB according to the relevant pick-up group codes and transmits the originating PID and switch information corresponding to the terminating call for which the pick-up request has been made; and a terminating pick-up process that is generated by the same processor as the terminating ringing process or by a different processor, searches the adjacent base station list DB and the terminating information DB if there is a call pick-up request, sends a call pick-up request to the terminating ringing process designated by the terminating PID corresponding to the number for the terminating call (which is to be picked up) belonging to the same pick-up group and located within the ringing signal audible area, and receives from the terminating ringing process the originating PID and switch information for the terminating call for which the pick-up request has been made and then notifies the originating process designated by the originating PID of the response to the terminating call.

The terminating ringing process terminates the terminating call after receiving from the terminating pick-up process the number of the mobile phone which requested the call pick-up and displaying the number through the base station controller on the mobile phone for which the terminating call is to be picked up, and deletes the terminating ringing information which has been registered and managed in the terminating information memory.

The terminating pick-up process, after receiving from the visitor location register the pick-up group code and location information of the subscriber who requested the call pick-up, searches the adjacent base station list DB by using the received pick-up group code to obtain information about the base station and/or sector located within the audible area of the ringing mobile phone, and searches the terminating information DB by using the location information and the information about the ringing signal audible area to obtain the terminating PID corresponding to the terminating call (which is to be picked up) belonging to the same pick-up group and located within the ringing signal audible area.

The present invention provides a call pick-up method to process a terminating call for a mobile phone by generating an originating process and terminating processes in a mobile communication system, comprising: registering in a terminating information memory the terminating ringing information including the numbers, group codes and location information of mobile phones currently receiving terminating calls and the relevant PIDs; if there is a call pick-up request from a mobile phone, searching, at the terminating pick-up process, the terminating ringing information in the terminating information memory by using the group code and location information of the pick-up requesting subscriber; sending a call pick-up request to the terminating ringing process designated by the terminating PID corresponding to the terminating call to be picked up, that is currently ringing, within the same group and within the coverage of the same base station or sector as the pick-up requesting subscriber; and notifying the originating process of the response to the terminating call by using the originating PID and switch information transmitted by the terminating ringing process as a response to the call pick-up request and, at the same time, connecting the communication line.

The group code, the information required in determining whether certain terminating call may be picked up or not, is the code to identify the relevant subscriber group where the mobile communication subscribers are classified as a group of subscribers who can pick up terminating calls for other subscribers in the same group.

The terminating PID corresponding to the terminating call that is to be picked up is the terminating PID obtained by searching the terminating information memory by using the group code and location information about the pick-up requesting subscriber and is the terminating PID of the terminating ringing process which is processing the terminating call for a mobile phone belonging to the same group and located within the coverage of the same base station or sector as the pick-up requesting subscriber.

The call pick-up method in a mobile communication network farther comprises: confirming whether there is a response to the terminating ringing or a call pick-up request before the time-out, by counting terminating ringing time from when the terminating ringing process informed the originating process of the terminating ringing status of the relevant mobile phone; and, if there is a call pick-up request, terminating the terminating call, releasing the registered terminating ringing information from the terminating information memory, and then transmitting to the terminating pick-up process the originating PID and switch information stored in the call register.

The call pick-up method in a mobile communication network further comprises notifying the originating process of the response to the terminating call if it is determined, from said confirmation of whether there is a response to the terminating ringing or a call pick-up request, that there has been a response to the terminating ringing before the terminating ringing time-out from the mobile phone at the terminating side. On the other hand, if it is determined, from said confirmation of whether there is a response to the terminating ringing or a call pick-up request, that there has been neither any response to the terminating ringing nor any call pick-up request before the terminating ringing time-out, the call pick-up method in a mobile communication network further comprises notifying the originating process of the call failure caused by the absence of any response and terminating the terminating call.

The call pick-up method in a mobile communication network further comprises: interpreting the terminating number included in the originating request message at the terminating pick-up process and thus confirming whether there has been a call pick-up request from a mobile phone; and, if there has been a call pick-up request from a mobile phone, receiving from a visitor location register the subscriber information including the group code and location information about the subscriber who requested the pick-up.

In said confirmation of whether there has been a call pick-up request from a mobile phone, if the interpretation of the terminating number included in the originating request message starts with specific digits indicating a call pick-up request, it is recognized that there has been a call pick-up request.

If the interpretation of the terminating number included in the originating request message at the terminating pick-up process confirms that the call pick-up request includes the number of the mobile phone to be picked up, the call pick-up method in a mobile communication network further comprises: searching the terminating information memory by using the number of the mobile phone to be picked up; and sending a call pick-up request to the terminating ringing process designated by the terminating PID corresponding to the terminating number of the mobile phone stored in the terminating information memory, which is the same as the number of the mobile phone to be picked up.

If the number of a mobile phone which requests the pick-up is received from the terminating pick-up process at the time of making a call pick-up request, the call pick-up method in a mobile communication network further comprises: displaying the received number on the mobile phone for which the terminating call is to be picked up through the relevant base station controller.

Moreover, the call pick-up method in a mobile communication network further comprises, at the originating process which received the notice of the response to the terminating call from the terminating pick-up process, renewing the terminating PID information which has been stored in its call register with the terminating PID of said terminating pick-up process, while making transition to the busy state.

A call pick-up method in a mobile communication network according to the present invention, wherein mobile communication subscribers may pick up terminating calls for other subscribers, comprises: registering in a terminating information DB the terminating ringing information including the numbers, location information of mobile phones receiving terminating calls and the relevant PIDs according to the relevant pick-up groups; if there is a call pick-up request from a mobile phone, searching, at the terminating pick-up process, the adjacent base station list DB and the terminating ringing information in the terminating information DB by using the group code and location information of the pick-up requesting subscriber; sending a call pick-up request to the terminating ringing process designated by the terminating PID corresponding to the currently ringing terminating call to be picked up, belonging to the same group as the pick-up requesting subscriber and located within the ringing signal audible area; and notifying the originating process of the response to the terminating call by using the originating PID and switch information transmitted by the terminating ringing process as a response to the call pick-up request and, at the same time, connecting the communication line.

The call pick-up method in a mobile communication network further comprises transmitting the originating PID and switch information to the terminating pick-up process after terminating, at the terminating ringing process, the terminating call for which the call pick-up request has been made and after releasing the registered terminating ringing information from the terminating information DB.

Sending a call pick-up request to the terminating ringing process comprises: searching the adjacent base station list DB by using the pick-up group code of the subscriber who requested the call pick-up to obtain information on the base stations and/or sectors located within the ringing signal audible area; searching the terminating information DB by using the location information of the subscriber who requested the call pick-up and the obtained information about the ringing signal audible area to obtain the terminating number for which the call pick-up can be performed, belonging to the same pick-up group and located within the ringing signal audible area; and sending a call pick-up request for the mobile phone currently being called to the terminating ringing process designated by the terminating PID corresponding to the obtained terminating number for which the call pick-up can be performed.

The adjacent base station list DB stores, for each base station sector, IDs of adjacent base stations and/or sectors located within the audible area where the mobile phone's ringing signal may be heard.

If mobile phones within the pick-up group, to which the subscriber who requested the call pick-up belongs, support the GPS function, the call pick-up method in a mobile communication network further comprises: receiving from the base station controller the GPS location information about the subscriber who requested the pick-up; searching the terminating ringing information registered in the terminating information DB by using the pick-up group code of the subscriber who requested the call pick-up and the received GPS location information; and, upon searching the terminating ringing information registered in the terminating information DB, sending a call pick-up request to the terminating ringing process designated by the terminating PID corresponding to the terminating number for which the terminating pick-up can be performed, belonging to the same pick-up group and located within the ringing signal audible area.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the call pick-up service in a mobile communication network according to a first embodiment of the present invention.

FIG. 2 illustrates a structure of a call pick-up system in a mobile communication network implemented according to an embodiment of the present invention.

FIG. 3 illustrates the terminating information memory shown in FIG. 2.

FIG. 4a illustrates operation flows for the call pick-up within the coverage of the same base station or sector in a mobile communication network according to a preferred embodiment of the present invention.

FIG. 4b illustrates the call pick-up operations within the coverage of the same base station or sector in a mobile communication network according to a preferred embodiment of the present invention.

FIG. 5 illustrates, of the operations shown in FIG. 4b, the operations of picking up a terminating call for a mobile phone by another mobile phone located within the coverage of the same base station or sector and of responding to the terminating ringing for communication.

FIG. 6 illustrates, of the operations shown in FIG. 4b, the operations of the terminating pick-up process' sending a call pick-up request to the terminating ringing process.

FIG. 7 illustrates a call pick-up system in a mobile communication network according to another preferred embodiment of the present invention.

FIG. 8 illustrates the terminating information DB shown in FIG. 7.

FIG. 9 illustrates an example of base station and mobile phone location for the purpose of explaining the determination of terminating calls that may be picked up in the call pick-up system in a mobile communication network according to said another preferred embodiment of the present invention.

FIG. 10 illustrates the adjacent base station list DB shown in FIG. 7.

FIG. 11a illustrates operation flows of the call pick-up within the audible area in a mobile communication network according to said another preferred embodiment of the present invention.

FIG. 11b illustrates the operations of the call pick-up within the audible area in a mobile communication network according to said another preferred embodiment of the present invention.

FIG. 12 illustrates, of the operations shown in FIG. 11b, the operations of picking up a terminating call for a mobile phone by another mobile phone located within the audible area and of responding to the terminating ringing for communication.

FIG. 13 illustrates, of the operations shown in FIG. 11b, the operations of the terminating pick-up process' sending a call pick-up request to the terminating ringing process.

### DETAILED DESCRIPTION OF PREFERRED EMBODIMENTS

In a mobile communication network according to a preferred embodiment of the present invention, a call pick-up service is provided where a terminating call directed to one mobile phone is picked up for answering and communication by another mobile phone. The two phones are preferably within the coverage area of the same base station or sector. Such call pick-up service may be performed for a certain time period during which the ringing for the terminating call of the certain mobile phone is maintained.

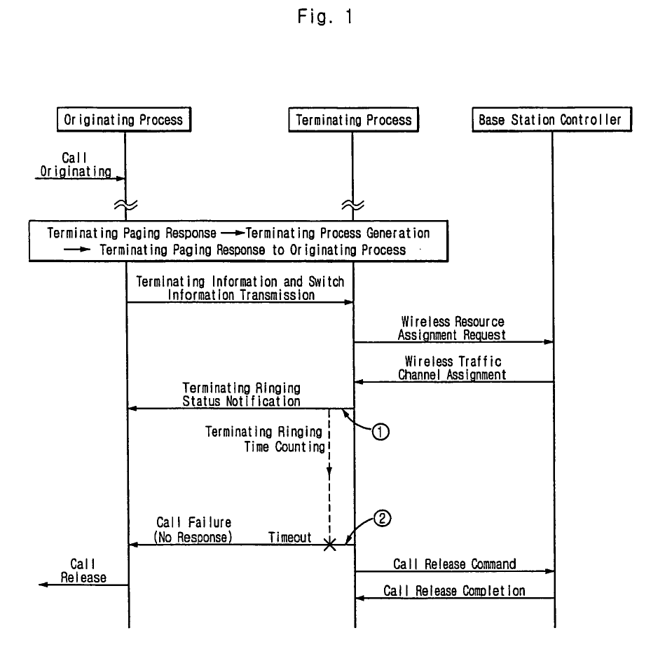

More specifically, as illustrated in FIG. 1, the call pick-up service in a mobile communication network according to a preferred embodiment of the present invention is performed in the following manner. A terminating process, which received terminating information and switch information from an originating process of a mobile switch system, receives a wireless traffic channel assignment from a base station controller and then notifies the originating process of the terminating call ringing status. From the time when the terminating call ringing status was notified to the originating process (1), the counter for the terminating call ringing time is operated until the time when a command to release the call is issued upon the time-out (2). If there is a call pick-up request by an adjacent mobile phone during the time between (1) and (2), the terminating call is transferred to the adjacent mobile phone which requested the call pick-up. Thus, a mobile phone other than the mobile phone to which the original terminating call is directed may answer the terminating call and can conduct the communication.

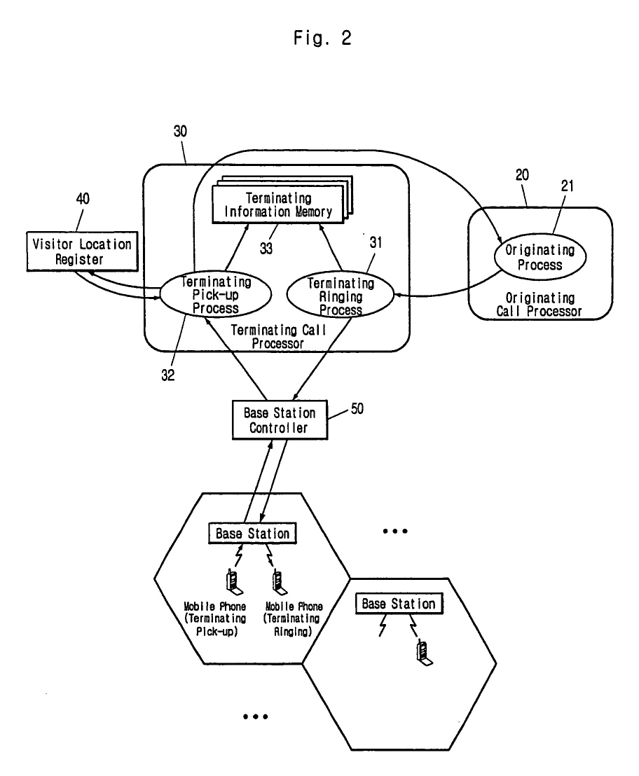

As illustrated in FIG. 2, a call pick-up system in a mobile communication network according to a preferred embodiment of the present invention comprises an originating call processor 20, a terminating call processor 30, a visitor location register 40 and a base station controller 50, for providing the above-described call pick-up service.

The originating call processor 20 generates an originating process 21 to perform the ordinary procedures of mobile originating call process such as the originating request, number interpretation and terminating location search, etc. and transmits the terminating information including the subscriber's group code and the switching information required for the communication line connection to the terminating call processor 30. The group code is information required to determine whether the call pick-up is possible. Mobile communication subscribers are classified into groups of subscribers who can pick up terminating calls for other subscribers within a same group (for example, a group being members of family or employees of one department of an office). Such groups are designated with group codes to be used as identifiers of the groups and such group codes are registered.

The terminating call processor 30 generates a terminating process to perform the ordinary procedures of terminating call process, registers in a terminating information memory 33 (which is a common memory) terminating ringing information about mobile phones currently receiving terminating calls in the respective terminating processes, including the numbers, group codes, location information (base station ID or sector ID, etc.) and terminating PIDs (Process IDs) and manages such information. Further, if there is a pick-up request for a terminating call by a mobile phone located within the coverage of the same base station or the same sector, the terminating call processor 30 terminates the terminating call processed in the prior terminating process 31 (referred to as “terminating ringing process”) and conducts the terminating pick-up process through a new terminating process which received the call pick-up request 32 (referred to as “terminating pick-up process”) so that the terminating call can be connected to the adjacent mobile phone for answering and communication.

Preferably, for the call pick-up service according to a preferred embodiment of the present invention, the terminating ringing process 31 registers in the terminating information memory 33 the terminating ringing information including the number, group code, location information of a mobile phone that the terminating ringing process 31 is calling and the process ID (terminating PID) of itself and manages such information. If there is a call pick-up request from a terminating pick-up process 32, the terminating ringing process 31 transmits the originating PID and switch information for the terminating call, for which the pick-up request has been made, from its call register to the terminating pick-up process 32 so that the terminating pick-up process 32 may be connected to the originating process, displays the number of the adjacent mobile phone which requested the call pick-up on the mobile phone to which the terminating call is originally directed through the base station controller 50 and then terminates the terminating call and deletes the terminating ringing information which has registered and managed in the terminating information memory 33.

If specific digits indicating a call pick-up request are inputted from an adjacent mobile phone located within the coverage of the same base station or the same sector as that of the mobile phone being called, the terminating pick-up process 32 searches the terminating information memory 33 to obtain the terminating PID of the terminating ringing process 31 which is processing the terminating call for which the pick-up has been requested and then requests a call pick-up by transmitting the number of the adjacent mobile phone requesting the pick-up to the terminating ringing process 31 corresponding to the terminating PID. Also, after receiving from the terminating ringing process 31 the originating PID and switch information regarding the terminating call for which the pick-up has been requested, the terminating pick-up process 32 notifies the originating process 21 designated by the originating PID of the originating response so that the terminating call currently being called may be picked up by the adjacent mobile phone for answering and communication.

The visitor location register 40 located within the mobile switch system stores and manages information regarding visiting subscribers. Specifically, it stores and manages subscriber information which includes subscriber group codes and location information of mobile phones, required in determining which terminating calls may be picked up. Also, the visitor location register 40 transmits the subscriber information including the group code and location information of a subscriber requesting a pick-up to the terminating pick-up process 32 of the terminating call processor 30.

The base station controller 40 performs the base station control and wireless resource management required in between the relevant switch system and the base station. Thus, it controls the assignment of wireless traffic channels in response to a call request of a mobile phone and controls communication line connection and disconnection.

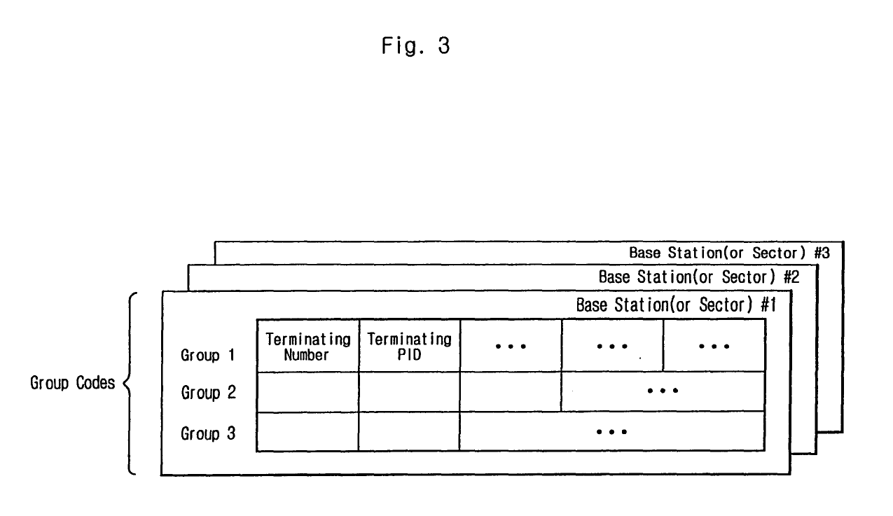

As illustrated in FIG. 3, the terminating information memory 33 stores terminating ringing information including numbers and location information of mobile phones currently being called by the terminating processes 31, 32, location information (base station ID, sector ID, etc.) and the relevant terminating PID (Process ID) according to the relevant base stations or sectors. At this time, group codes required in determining which terminating calls may be picked up are stored together. Preferably, the terminating information memory 33 is a common memory shared by terminating processes 31, 32.

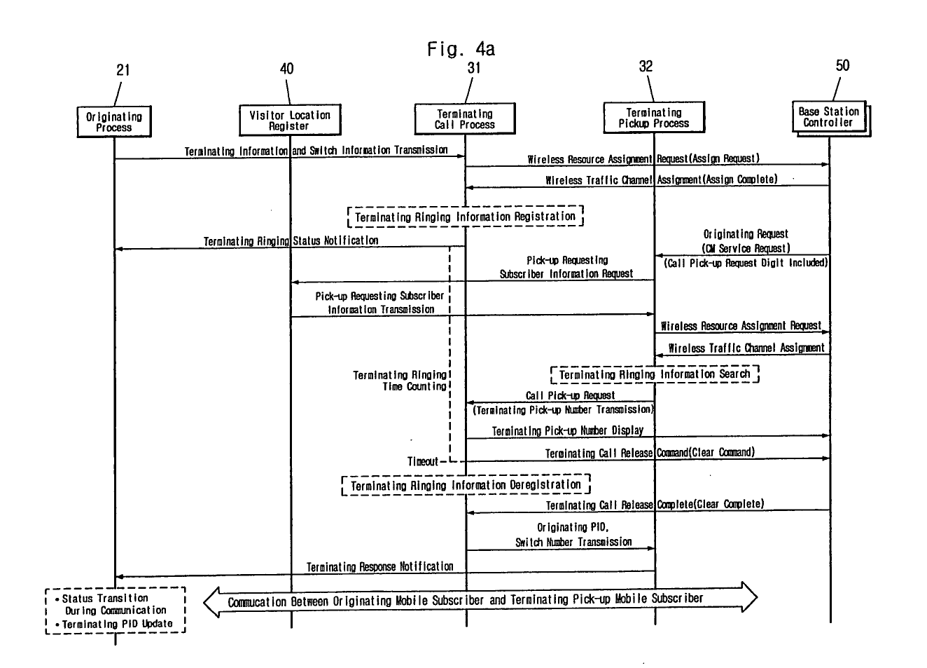

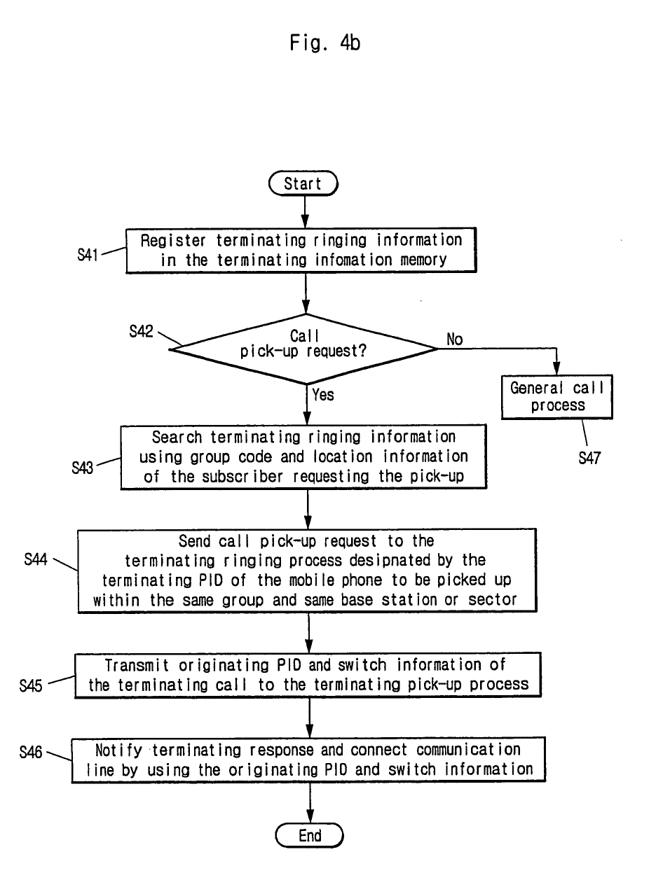

FIGS. 4a and 4b show steps included in a call pick-up operation performed within the coverage area of a base station or sector in a mobile communication network, which includes the above-described call pick-up system.

As a first step, if there is a terminating call at one mobile phone, the terminating ringing process 31 of the mobile switch system registers in the terminating information memory 33 the information regarding terminating ringing required in determining whether the terminating call may be picked up, i.e., the terminating ringing information including the number, group code and location number of the mobile phone that the terminating ringing process 31 is currently calling and the terminating PID of itself (Step S41).

At this time, the terminating pick-up process 32 checks whether there is any call pick-up request from another mobile phone (Step S42). If there is no call pick-up request, the terminating ringing process 31 conducts the ordinary call process, e.g., response to the terminating ringing or call failure process if the terminating call is not answered (Step S47).

If it is determined at step S42 that there has been a call pick-up request from another mobile phone, the terminating pick-up process 32 receives from the visitor location register 40 information regarding the subscriber who is currently requesting the call pick-up, such as the group code and location information, and searches the terminating ringing information registered in the terminating information memory 33 using such group code and location information of the subscriber requesting the call pick-up (Step S43). Then, the terminating pick-up process 32 sends a call pick-up request to the terminating ringing process 31 designated by the terminating PID of the mobile phone currently being called within the coverage of the same base station or sector, having the same group code as the subscriber requesting the terminating pick-up (Step S44).

Thereafter, when the terminating pick-up process 32 receives from the terminating ringing process 31 the originating PID and switch information regarding the terminating call stored in the call register as a response to the call pick-up request (Step S45), the terminating pick-up process 32 notifies the originating process of the terminating response using the received originating PID and switch information and connects the communication line at the same time (Step S46). In this manner, a mobile communication subscriber located within the coverage of the same base station or sector and having the same group code as the mobile phone currently being called may communicate with a mobile communication subscriber who originated the call.

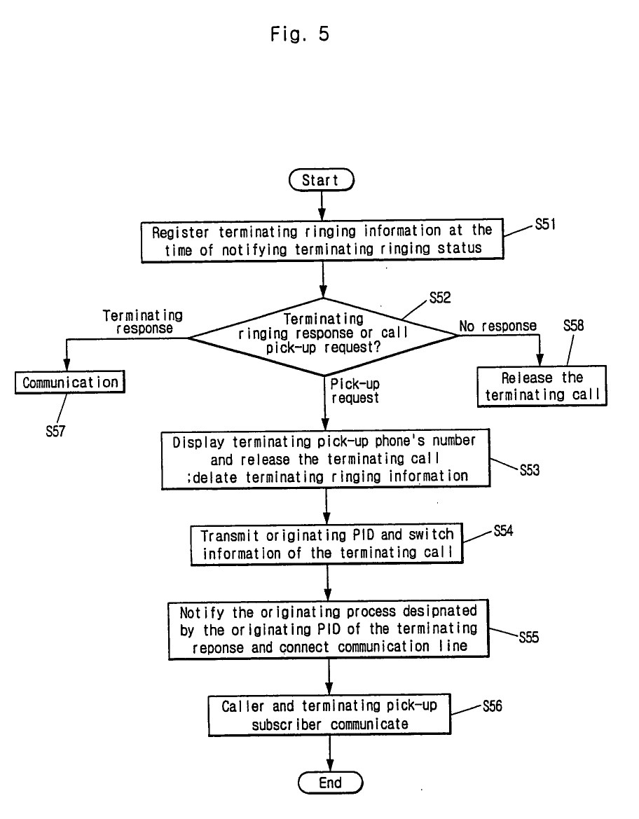

FIG. 5 shows steps included in an operation of picking up a terminating call of a mobile phone by another mobile phone located within the coverage of the same base station and sector, for responding to the terminating ringing according to the above-described preferred embodiment of the present invention.

When the originating process 21 of a mobile switch system transmits terminating information and switch information to the terminating ringing process 31 for the terminating call process of a mobile phone, the terminating ringing process 31 requests the base station controller 50 to assign wireless resource and receives assignment of a wireless traffic channel. Thereafter, the terminating ringing process 31 performs the procedure to notify the originating process 21 of the terminating ringing status. When the terminating ringing status is notified, the terminating ringing process 31 receives from the originating process 21 the terminating information including the group code of the mobile phone to which the terminating call is directed and registers in the terminating information memory (common memory) the information regarding the terminating ringing required in determining which terminating calls can be picked-up, i.e., the terminating ringing information including the number, group code and the location information of the mobile phone that the terminating ringing process 31 itself is calling and the terminating PID (Step S51).

Further, from the time the terminating ringing process 31 notifies the originating process 21 of the terminating ringing status, the terminating ringing process 31 counts time through the terminating ringing timer and checks whether there is any response to the terminating ringing before the timeout occurs and checks whether there is a call pick-up request (Step S52).

If there is a response to the terminating call at the mobile phone receiving the terminating call before the terminating ringing timeout, the terminating ringing process 31 notifies the originating process 21 of the terminating response so that the mobile communication subscriber at the originating side and the mobile communication subscriber at the terminating side may communicate with each other (Step S57).

Further, if there is neither any response to the terminating ringing nor any call pick-up request before the terminating ringing timeout, the terminating ringing process 31 notifies the originating process 21 of the call failure caused by no response to the terminating call, stops counting the terminating ringing timer, and sends call clear command to the base station controller 50 to terminate the terminating call that the terminating ringing process 31 has been calling (Step S58).

In contrast, if it is determined in Step S52 that there is a call pick-up request before the terminating ringing timer's timeout, as a response to the terminating pick-up request, the terminating ringing process 31 transmits the originating PID and switch information corresponding to the terminating call, which has been stored in the terminating ringing process 31's call register, to the terminating pick-up process 32 so that the terminating pick-up process 32 which made the pick-up request may be connected with the originating process (Step S54). At this time, the terminating ringing process 31 receives the number of the mobile phone which made the call pick-up from the terminating pick-up process 32 and displays it on the mobile phone which is currently being called through the base station controller and then terminates the terminating call. Further, the terminating ringing process 31 deletes the terminating ringing information regarding the terminating call which has been registered and managed in the terminating information memory 33 (Step S53).

Then, the terminating pick-up process 32 which received the originating PID and switch information of the terminating call from the terminating ringing process 31 stores such information in its call register, notifies the originating process 21 designated by the originating PID of the terminating response so that the transition can be made to the busy state and connects the communication line using the switch information (Step S55). Thus, the terminating call directed to a mobile phone located within the coverage of the same base station or sector and having the same group code is picked up by another mobile phone and answered. As a result, the mobile communication subscriber at the originating side may communicate with the mobile communication subscriber who requested the terminating pick-up (Step S56).

The originating process 21 which has been notified of the terminating response makes the transition to the busy state and updates the terminating PID information stored in its call register by replacing the terminating PID of the terminating ringing process 31 with the terminating PID of the terminating pick-up process 32.

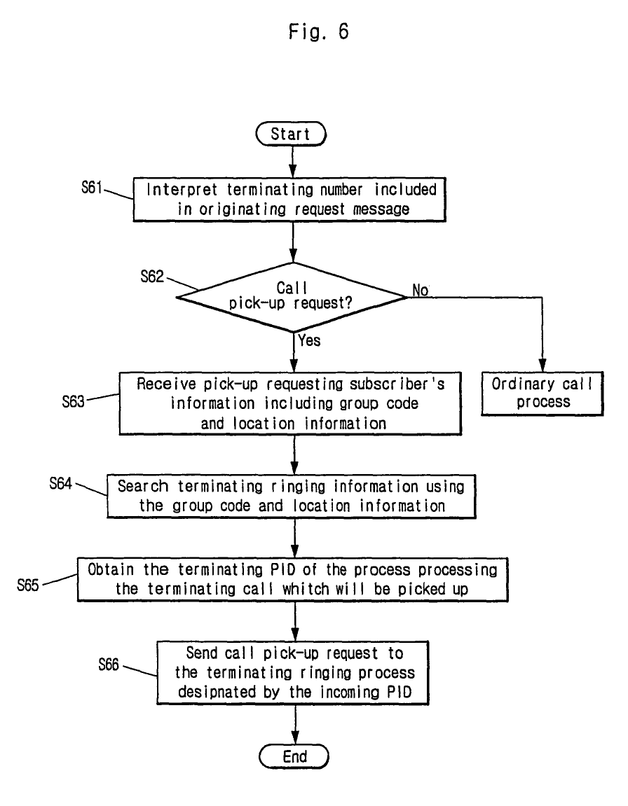

FIG. 6 shows steps included in the terminating pick-up process 32's operation of sending the call pick-up request to the terminating ringing process 31 in accordance with the preferred embodiment of the present invention.

If specific digits indicating a call pick-up request are inputted, the terminating pick-up process 32 makes a call pick-up request to the terminating ringing process 31, which is processing the terminating call for which the pick-up request is currently made. At this time, the terminating pick-up process 32 interprets the terminating number included in the originating request message transmitted through the base station controller 50 by inter-operating with a number interpretation process (not shown in the drawing) (Step S61). In this manner, the terminating pick-up process 32 checks whether the terminating number is a number starting with specific digits indicating a call pick-up request, i.e., whether there is a call pick-up request from a certain mobile phone (Step S62).

If it is determined that there has been a call pick-up request from a certain mobile phone, the terminating pick-up process 32 requests the visitor location register 40 to send information about the subscriber who is currently making the call pick-up request and receives such information. By receiving the subscriber information including the group code and location information of the subscriber who is requesting the pick-up (Step S63), the terminating pick-up process 32 may request the call pick-up to the terminating ringing process 31 which is processing the terminating call for the mobile phone belonging to the same group and located within the coverage of the same base station and sector as the subscriber who made the pick-up request and, on the other hand, requests the base station controller 50 to assign wireless resource and thus receives certain wireless traffic channel.

In other words, out of the information regarding the subscriber requesting the pick-up, which was transmitted from the visitor location register 40, the terminating pick-up process 32 uses the subscriber's location information and group code to search the terminating ringing information which is registered in the terminating information memory 33 (Step S64) and extracts, among information about mobile phones currently being called, the number of the mobile phone which is located within the coverage of the same base station or sector and has the same group code as the subscriber who is presently requesting the pick-up. If more than one mobile phone having the same group code within the coverage of the same base station or sector are currently being called, the number of the mobile phone which has first been registered in the terminating information memory 33 is preferably extracted.

Then, by searching the terminating information memory 33, the terminating PID of the terminating ringing process 31 processing the terminating call for the number of the mobile phone which will be picked-up (i.e., the number of the mobile phone which has been extracted in the above step) is extracted and obtained (Step S65) and the call pick-up request for the currently called mobile phone is made to the terminating ringing process 31 having the extracted terminating PID (Step S66).

The terminating pick-up process 32 transmits the number of the terminating pick-up mobile phone (i.e., the mobile phone which made the pick-up request) to the terminating ringing process 31. Thus, the number of the terminating pick-up mobile phone which picked up the terminating call may be displayed on mobile phone to which the terminating call was originally directed. Further, the terminating pick-up process 32, through the call pick-up request to the terminating ringing process 31, receives the originating PID and switch information, etc. regarding the terminating call for which the pick-up request has been made. Thus, the connection to the originating process 21 having the above-received originating PID is made, and as a result the subscriber at the originating side and the subscriber who requested the call pick-up may communicate with each other.

In a preferred embodiment of the present invention wherein a mobile communication subscriber located within the coverage of the same base station or sector as the mobile phone currently being called may request the call pick-up using his or her own mobile phone, the mobile communication subscriber may request the call pick-up either by dialing specific digits indicating the call pick-up request and the send button (i.e., dialing “**”+“send button”) or by dialing specific digits indicating the call pick-up request, the number of the mobile phone whose terminating call is requested to be picked up, and the send button (i.e., dialing “**”+“mobile phone number”+“send button”).

If the method of dialing the phone number of the mobile phone for which the terminating call will be picked up is used, either the entire mobile phone number including the mobile signal carrier's identifying number (e.g., 011, 016, 017, 018, 019 etc.) or a portion thereof (e.g., 123-4567 or 4567 of the number 011-123-4567) may be dialed for the call pick-up request.

In the case where the number of the mobile phone for which the terminating call will be picked up is dialed for the call pick-up request, the terminating pick-up process 32 searches the terminating ringing information registered in the terminating information memory 33 using the number of the mobile phone to be picked up, which was dialed when the terminating pick-up request was made. Process 32 then extracts, among the numbers of mobile phones that are currently being called, the number that is identical with the mobile phone number dialed for the terminating pick-up request. The terminating pick-up processor may also search the terminating information memory 33 with the location information and group code of the subscriber requesting the pick-up, which was transmitted from the visitor location register 40, and extracts among the numbers of mobile phones which are currently being called, the number of the mobile phone which has the same group code and is located within the coverage of the same base station or sector as the subscriber currently requesting the pick-up, as in the above-described preferred embodiment of the present invention.

The call pick-up request may be made by a mobile communication subscriber located within the coverage of the same base station or sector as the mobile phone which is currently being called because the ringing signal of the mobile phone currently being called may not be heard if the subscriber is out of the coverage of the same base station or sector. However, if the subscriber is located within the coverage of another base station or sector (e.g., one adjacent to the base station or sector covering the mobile phone currently being called), then the subscriber located within the coverage of such adjacent base station or sector may also make a call pick-up request.

In this connection, in the above-described preferred embodiment of the present invention, the terminating ringing information of the mobile phone currently being called is registered and managed in the terminating information memory, which is the common memory of processors constituting the terminating call processor, and such information is searched for providing the pick-up service. Because each processor constituting a terminating call processor is connected to each of the relevant base station controllers, the call pick-up service can be provided only for the terminating pick-up request made under the same base station controller (i.e., only for the terminating pick-up request made within the coverage of the same base station or sector). Hereinafter, in accordance with another preferred embodiment of the present invention, the call pick-up service for mobile phones located within the coverage of different adjacent cells will be explained.

In another preferred embodiment of the present invention, if a terminating call arrives at a certain mobile phone, another mobile phone located in an area where the former mobile phone's ringing signal can be heard can pick up the terminating call and answer the phone. This call pick-up service is also provided during a certain time period for which the ringing for the terminating call continues, as in the above-described first preferred embodiment of the present invention.

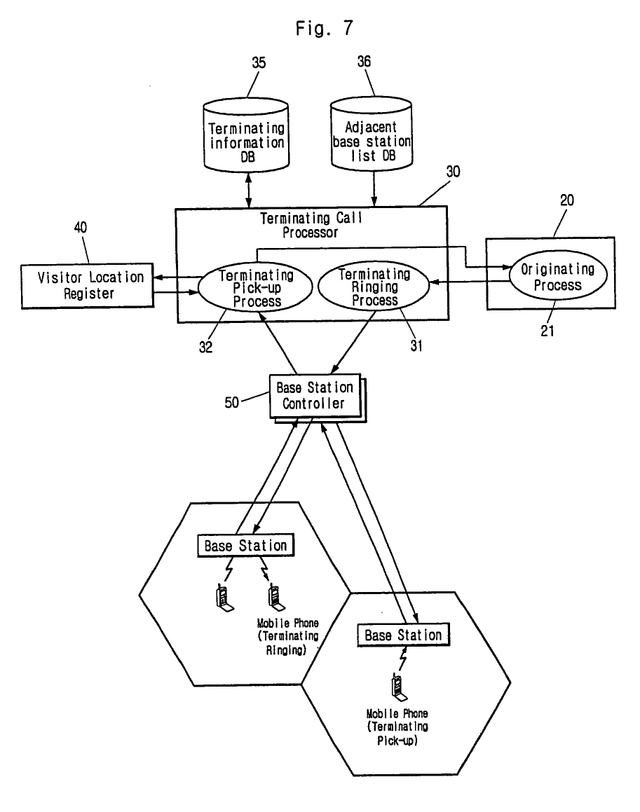

As illustrated in FIG. 7, the call pick-up system in a mobile communication network according to another preferred embodiment of the present invention comprises an originating call processor 20 and a terminating call processor 30, constituted by a number of processors, a terminating information database DB 35 storing various terminating ringing information, an adjacent base station list 36 storing information of adjacent base stations, a visitor location register 40 and a base station controller. The same reference numerals are given for the same parts of the present invention illustrated in FIG. 2.

The originating call processor 20 generates an originating process 21 to perform the ordinary procedures of a mobile originating call process (such as the originating request, number interpretation and terminating location search, etc.) and transmits the terminating information including the subscriber's group code and the switching information required for the communication line connection to the terminating call processor 30. The group code is information required to determine whether the call pick-up is possible. Mobile communication subscribers are classified into groups of subscribers who can pick-up terminating calls for other subscribers within same group (for example, a group being members of family or employees of one department of an office). Such groups are designated with group codes to be used as identifiers of the groups and such group codes are registered.

The terminating call processor 30 generates a terminating process to perform the ordinary procedures of terminating call process, and registers in a terminating information database DB 35 terminating ringing information about mobile phones currently receiving terminating calls in the respective terminating processes. The terminating ringing information may indicate or include one or more of numbers, group codes, location information (base station ID or sector ID, etc.) and terminating PIDs (Process IDs). Further, if there is a pick-up request for a terminating call by a mobile phone located within the audible area, the terminating call processor 30 terminates the terminating call processed in the prior terminating process (i.e., the terminating ringing process) 31 and transfers the terminating call to the mobile phone requesting the pick-up through the terminating pick-up process 32, so that the terminating call may be connected and answered.

The terminating ringing process 31 and the terminating pick-up process 32 may be generated by processors connected to different base station controllers. The terminating ringing process 31 registers in the terminating information database DB 35 the terminating ringing information including numbers and location information of a mobile phone that the terminating ringing process 31 is currently calling and the process ID of itself (terminating PID) preferably by classifying it with the group code. If there is a call pick-up request from the terminating pick-up process 32 generated in the same processor or another processor, the terminating ringing process 31 transmits the originating PID and switch information of the terminating call for which the pick-up has been requested, which was stored in its call register, to the terminating pick-up process 32 so that the terminating pick-up process 32 may be connected to the originating process 21. The terminating ringing process 31 displays the number of the mobile phone requesting the call pick-up on the mobile phone which is currently being called through the base station controller 50 and then terminates the original terminating call. Further, the terminating ringing process 31 releases the relevant terminating ringing information from the terminating information database DB 35.

If specific digits indicating a call pick-up request are inputted from a mobile phone, the terminating pick-up process 32 extracts from the adjacent base station list database DB 36 the base station and sector information within the audible area where the ringing signal of the mobile phone currently being called can be heard. Then, the terminating pick-up process 32 searches the terminating information database DB 35, extracts the number of the mobile phone located within the audible area among the numbers belonging to the same group and then obtains the corresponding terminating PID. Then, while transmitting to the terminating ringing process 31 designated by the obtained terminating PID the number of the mobile phone which requested a pick-up, the terminating pick-up process 32 makes the call pick-up request. Then, after receiving from the terminating ringing process 31 the originating PID and switch information of the terminating call for which the pick-up has been requested, the terminating pick-up process 32 notifies the originating process 21 designated by the originating PID of the response to the terminating call. In this manner, the terminating call may be picked up by another mobile phone located within the audible area and thus the communication may be conducted.

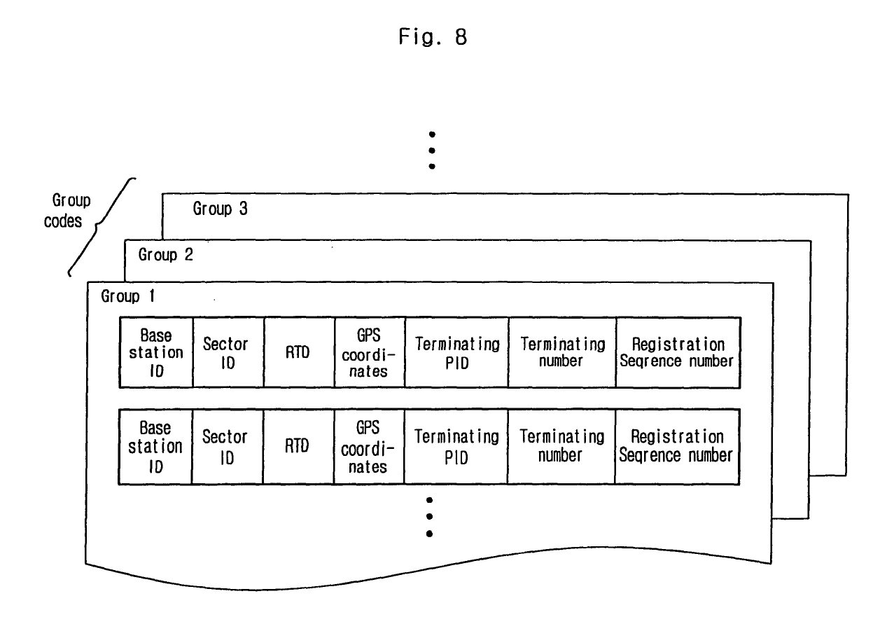

The terminating information DB 35 which is a database searched by the terminating call processor 30, as illustrated in FIG. 8, stores the terminating ringing information including the numbers and location information (base station ID, sector ID, RTD (Round Trip Delay) value, GPS coordinates, etc.) of mobile phones currently being called by the relevant terminating process 31 and 32 and the terminating PIDs (Process ID) as tuples according to the relevant group codes which are required in determining the terminating call that may be picked-up. At this time, the sequence number which will be used for the first-in first-out search standard may be stored together with the above information.

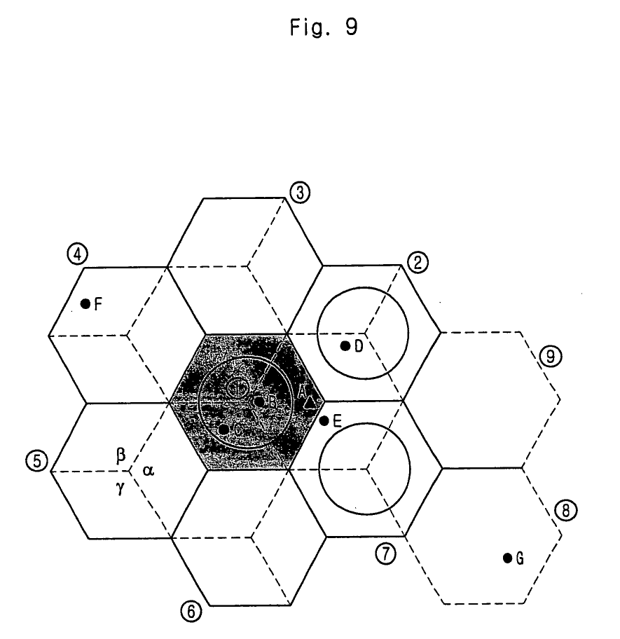

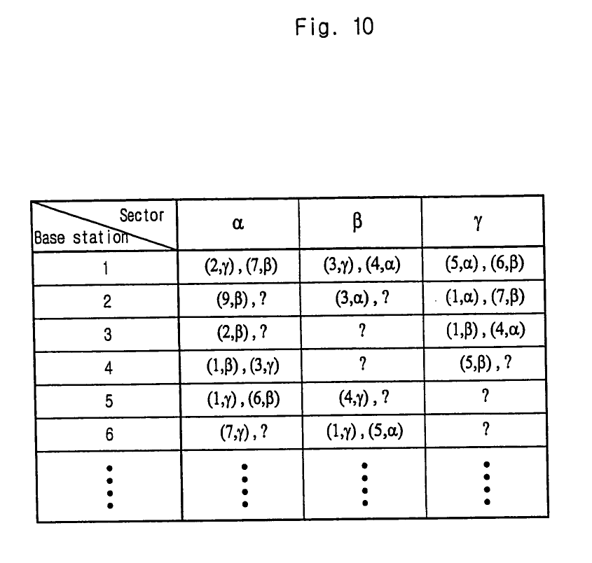

The adjacent base station list DB 36 is a database to indicate base stations and sectors within the audible area of the mobile phone which requests a pick-up service (i.e., the area where ringing signal of the mobile phone which is currently being called can be heard) and stores IDs of adjacent base stations and sectors for each base station sector, without regard to the base station controller. For example, if base stations are located as illustrated in FIG. 9, the database will be structured as shown in FIG. 10. Such database may be constructed by referring to the adjacent base station list information used in the hand-off function. Here, the example has three sectors. However, in the case of omni base stations, there may be no sector distinction. Further, there may be more than three or less than three sector distinctions in a base station. On the other hand, if the mobile phone receiving the terminating call and the mobile phone requesting the terminating pick-up are both mobile phones supporting GPS, then the above-described adjacent base station list DB 36 needs not be separately managed by the terminating call processor 30.

The visitor location register 40, included in a mobile switching system, stores and manages information about visiting subscribers. In other words, it stores and manages subscriber information which includes subscriber group codes and location information of mobile phones which are required in determining which terminating calls may be picked up, and transmits the subscriber information of the subscriber who requested the pick-up (including the group code and location information) to the terminating pick-up process 32 of the terminating call processor 30.

The base station controller 50, in between the switching system and base stations, conducts the base station control and wireless resource management. Thus, it controls the assignment of wireless traffic channels in response to call requests of mobile phones and connects or releases communication lines.

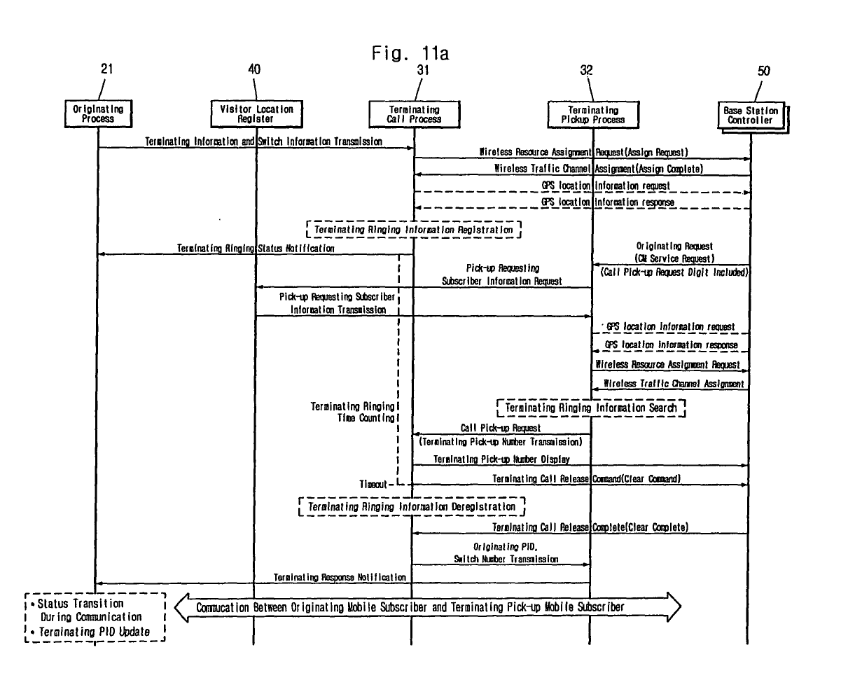

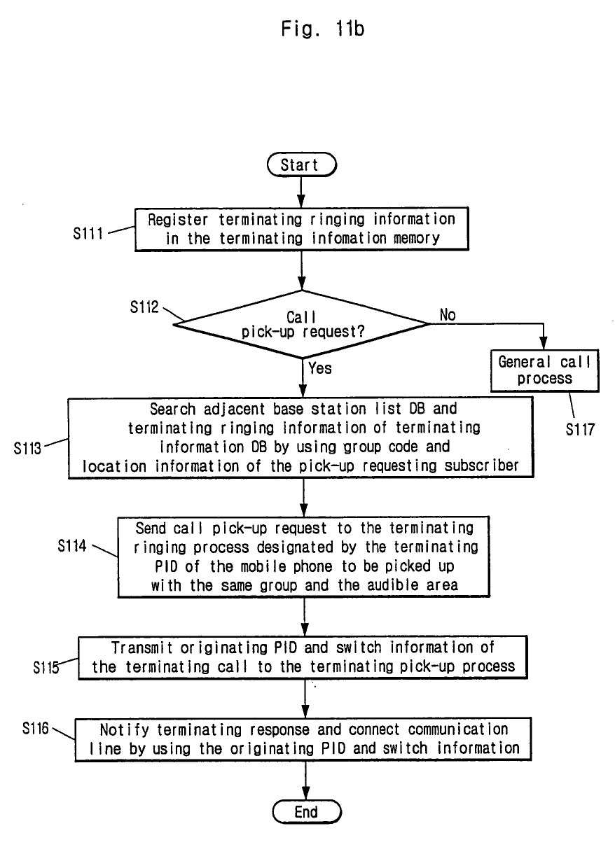

FIGS. 11a and 11b show steps included in a call pick-up operation within the audible area in a mobile communication network comprising the above-explained call pick-up system.

In order to provide call pick-up services when mobile phones receive terminating calls, the terminating ringing process 31 of the mobile switching system registers information about the terminating ringing required in determining which terminating calls may be picked up (i.e., the terminating ringing information including numbers, location information of the mobile phones that the terminating ringing process 31 itself is calling and the terminating PID) in the terminating information DB 35 according to the relevant group codes (Step S111).

The other terminating process according to the present invention, namely the terminating pick-up process 32, checks whether there is any call pick-up request from another mobile phone (Step S112). If there is no call pick-up request, the terminating ringing process 31 executes the relevant ordinary call process (e.g., response to the terminating ringing or call failure process if there is no response to the terminating call) (Step S117).

If it is determined at the Step S112 that there has been a call pick-up request from another mobile phone, the terminating pick-up process 32 searches the adjacent base station list DB 36 and the terminating ringing information registered in the terminating information DB 35. This search is preferably performed using the group code and location information of the subscriber currently requesting the call pick-up, which is transmitted from the visitor location register 40 (Step S113). Then, the terminating pick-up process 32 makes a call pick-up request to the terminating ringing process 31 having the terminating PID of the mobile phone whose terminating call is to be picked up (i.e., the mobile phone which is currently being called within the audible area and having the same group code as the subscriber requesting the pick-up) (Step S114).

Thereafter, if the terminating pick-up process 32 receives from the terminating ringing process 31 the originating PID and switch information, etc. of the terminating call, registered in the call register, as a response to the call pick-up request (Step S115), then the terminating pick-up process 32 notifies the originating process 21 of the response to the terminating call and connects the communication line by using the received originating PID and switch information (Step S116). In this manner the mobile communication subscriber, who belongs to the same group code and who can hear the ringing signal of the mobile phone currently being called, may communicate with the mobile communication subscriber at the originating side.

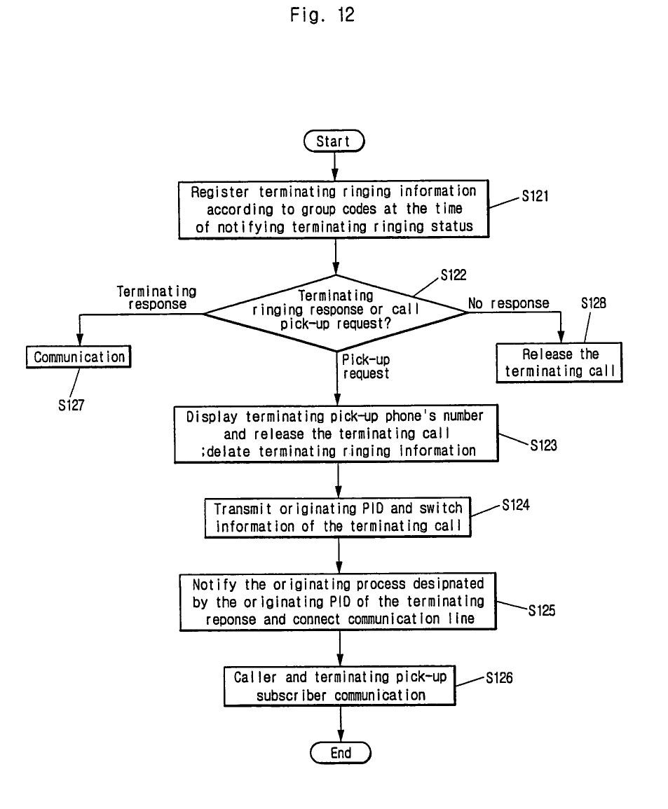

FIG. 12 shows steps included in a call pick-up operation performed by another mobile phone within an audible area without regard to the cell boundary in the above-described another preferred embodiment of the present invention.

As with the general terminating call process in an ordinary mobile communication network, if the originating process 21 of the mobile switching system transmits terminating information and switch information to the terminating ringing process 31, the terminating ringing process requests the base station controller 50 to assign wireless resources. After receiving a wireless traffic channel, the terminating ringing process 31 notifies the originating process 21 of the terminating ringing status.

Then, the terminating ringing process 31 receives from the originating process 21 the terminating information of the mobile phone to which the terminating call is directed. If the received terminating information includes a group code, this means that the subscriber of the mobile phone is a user of the terminating pick-up service. Thus, in this case, the terminating ringing process 31 registers terminating ringing information required in determining which terminating call may be picked up (i.e., the number and location information of the mobile phone that the terminating ringing process 31 itself is currently calling and the terminating PID) in the terminating information DB 35 according to the relevant group code (Step S121).

The location information is preferably included in the terminating ringing information registered in the terminating information DB 35 and may comprise a base station ID, sector ID, RTD (Round Trip Delay) value, GPS coordinates, etc. Thus, if the mobile phone currently being called is a handset supporting the GPS, the terminating ringing process 31 may request the base station controller 50 to provide GPS location information to thereby receive such information. Thereafter, the terminating ringing process 31 registers the terminating ringing information together with the received GPS location information in the terminating information DB 35.

Then, from the time when the terminating ringing process 31 notified the originating process 21 of the terminating ringing status, the terminating ringing process 31 checks whether there is a response to the terminating ringing before the time-out of the terminating ringing timer, and at the same time checks whether there is a call pick-up request (Step S122).

If there is a response to the terminating ringing from the mobile phone at the terminating side before the terminating ringing time-out, the terminating ringing process 31 notifies the originating process 21 of the response to the terminating call and enables the subscribers at the originating side and the terminating side to communicate with each other (Step S127).

If there is neither a response to the terminating ringing nor a call pick-up request before the terminating ringing time-out, the terminating ringing process 31 notifies the originating process 21 of the call failure for the reason of no response to the terminating call and sends a command to the base station controller 50 to release the call. In this manner, the current terminating call is terminated (Step S128).

In contrast, if there is a call pick-up request before the time-out of the terminating ringing timer at the step S122, as a response to the terminating pick-up request, the terminating ringing process 31 transmits to the terminating pick-up process 32 the originating PID and switch information of the terminating call which is registered in its call register so that the terminating pick-up process 32 which requested the pick-up may be connected to the originating process 21 (Step S124). At this time, the terminating ringing process 31 receives from the terminating pick-up process 32 the number of the terminating pick-up mobile phone (i.e., the mobile phone which requested the call pick-up) and displays the number on the mobile phone which is currently being called through the base station controller 50. Then, the terminating ringing process 31 terminates the terminating call. Further, the terminating ringing process 31 deregisters the terminating ringing information of the terminating call which has been registered and managed in the terminating information DB 33 (Step S123).

The terminating pick-up process 32, which received the originating PID and switch information of the terminating call from the terminating ringing process 31, stores such information in its call register and notifies the originating process 21 designated by the received originating PID of the response to the terminating call. Thus, the transition is made to the busy state and the communication line is connected through the use of the switch information (Step S125). In this manner, a mobile phone located nearby within an audible area where the ringing signal of the mobile phone currently being called may be heard can pick up the terminating call of another mobile phone belonging to the same group code and communicate with the caller even if the mobile phones are not located within the coverage of the same base station or sector (Step S126).

The originating process 21 which has been notified of the response to the terminating call makes transition to the busy state and renews the terminating PID information stored in its call register for transmission of signals such as the call release. Thus, the terminating PID information changes from the terminating PID of the terminating ringing process 31 to the terminating PID of the terminating pick-up process 32.

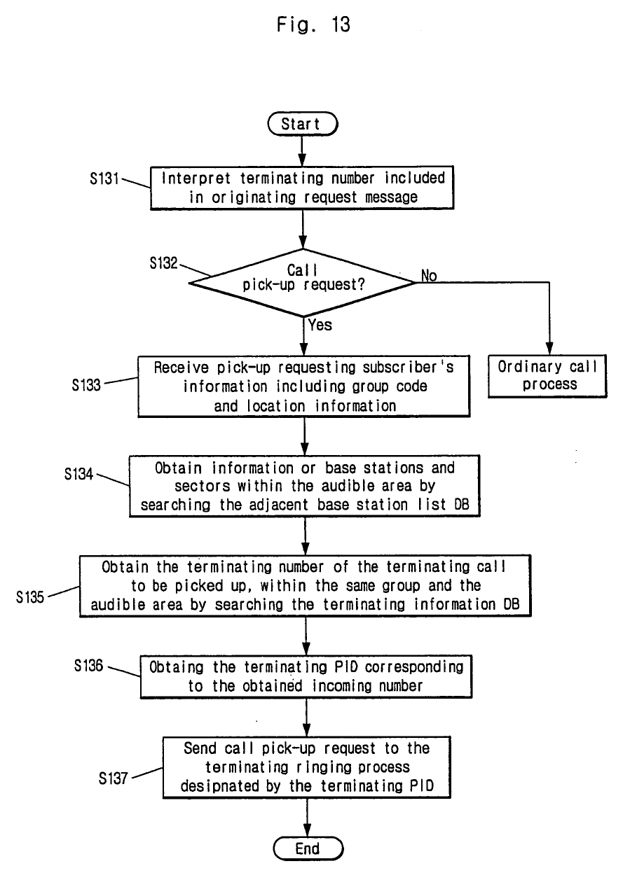

FIG. 13 shows how terminating pick-up process 32 operates to request a call pick-up to the terminating ringing process 31.

If certain digits indicating the call pick-up request are inputted, the terminating pick-up process 32 sends a call pick-up request to the terminating ringing process 31 which is processing the terminating call for which the pick-up request has been made. At this time, the terminating pick-up process 32 interprets the terminating number included in the originating request message transmitted through the base station controller 50 by inter-operation with the number interpretation process (not shown in the drawing) (Step S131). In this manner, it is checked whether the terminating number starts with certain digits (for example, “**”) indicating the call pick-up request, i.e., it is checked whether there is any call pick-up request from another mobile phone (Step S132).

If it is determined that there has been a call pick-up request from certain mobile phone, the terminating pick-up process 32 requests the visitor location register 40 to send information about the subscriber currently requesting the call pick-up and receives such information. Thus, the terminating pick-up process 32 receives the pick-up requesting subscriber's information including the group code and location information (Step S133). In this manner, the call pick-up request may be made to the terminating ringing process 31 executing the terminating call process for a mobile phone located within the audible area of the pick-up requesting subscriber and belonging to the same group. Further, the terminating pick-up process 32 requests the base station controller 50 to assign wireless resources, and as a result receives a certain wireless traffic channel.

In other words, the terminating pick-up process 32 searches the adjacent base station list DB 36 and the terminating ringing information registered in the terminating information DB 35 using the location information and group code of the pick-up requesting subscriber, obtained from the information about the pick-up requesting subscriber transmitted from the visitor location register 40, and extracts (retrieves) the number of the mobile phone belonging to the same group code as the subscriber currently requesting the pick-up and located within the audible area, out of the mobile phones that are currently receiving terminating calls.

More specifically, the terminating pick-up process 32 searches the adjacent base station list DB 36 with the location information of the pick-up requesting subscriber and obtains information of base stations and sectors located within the audible area where the pick-up requesting subscriber may hear ringing signal, i.e., the information of base stations and sectors adjacent to the base station and sector where the pick-up requesting subscriber is located (Step S134).

Then, the terminating pick-up process 32 searches the terminating information DB 35 using the above-obtained information of base stations and sectors, and out of the mobile phones currently receiving terminating calls obtains the number of the mobile phone belonging to the same group as the subscriber currently requesting the pick-up and located in the base stations and sectors within the audible area. At this time, if there is more than one mobile phone belonging to the same group code and located in the audible area of such mobile phones, the mobile phone which was first registered in the terminating information DB 35 is preferably selected as the mobile phone whose terminating call is to be picked up (Step S135).

After the terminating number of the mobile phone whose terminating call will be picked up is obtained, the terminating PID corresponding to the obtained terminating number (i.e., the terminating PID of the terminating ringing process 31 which is processing the terminating call of the mobile phone which will be picked up) is retrieved (Step S136). Thus, the call pick-up request may be made to the terminating ringing process 31 designated by the terminating PID, for the mobile phone currently receiving a terminating call (Step S137).

Then, the terminating pick-up process 32 transmits the number of the pick-up requesting mobile phone to the terminating ringing process 31 so that the number of the call pick-up mobile phone which picked up the terminating call may be displayed on the mobile phone which is currently receiving the terminating call. Further, through the call pick-up request to the terminating ringing process 31, the terminating pick-up process 32 receives the originating PID and switch information of the terminating call for which the pick-up request is made. As a result, the terminating pick-up process 32 may connect the originating process 21 designated by the received originating PID and enables the users of the originating mobile phone and the pick-up requesting mobile phone to communicate with each other.

During retrieval of the number of the mobile phone whose terminating call is to be picked up by the terminating pick-up process 32, if all the mobile phones belonging to the same group support a GPS function, the number of the mobile phone whose terminating call will be picked up can be obtained without using the adjacent base station list DB 36.

More specifically, if there is a call pick-up request from a certain mobile phone, the terminating pick-up process 32 requests the visitor location register 40 to provide information about the subscriber currently requesting the call pick-up. One process 32 receives the subscriber information including the group code, it preferably (or at the same time the VLR request is made) at the same time, requests the base station controller 50 to provide GPS location information. The terminating pick-up process receives the GPS location information about the pick-up requesting subscriber and then searches the terminating ringing information registered in the terminating information DB 35 using the group code and GPS location information obtained as described above. Process 32 also extracts the number of the mobile phone which belongs to the same group code as the pick-up requesting subscriber and which is located within the audible area where the ringing signal may be heard.

To summarize, in the first preferred embodiment of the present invention, a mobile communication subscriber located within the audible area may request the call pick-up even if the mobile phone which is receiving the terminating call is not within the coverage of the same base station or sector. Also, the mobile communication subscriber may request the call pick-up either by dialing specific digits indicating the call pick-up request and the send button (i.e., dialing “**”+“send button”) or by dialing specific digits indicating the call pick-up request, the number of the mobile phone whose terminating call is requested to be picked up, and the send button (i.e., dialing “**”+“mobile phone number”+“send button”).

If the method of dialing the phone number of the mobile phone for which the terminating call will be picked up is used, either the entire mobile phone number including the mobile signal carrier's identifying number (e.g., 011, 016, 017, 018, 019 etc.) or a portion thereof (e.g., 123-4567 or 4567 of the number 011-123-4567) may be dialed for the call pick-up request.

If the number of the mobile phone whose terminating call is to be picked up is dialed as well for the call pick-up request in the above-described preferred embodiment of the present invention, the terminating pick-up process 32 may search the terminating ringing information registered in the terminating information DB 35 using the dialed number of the mobile phone whose terminating call is to be picked up. Process 32 may then obtain from the numbers of mobile phones currently receiving terminating calls the terminating number of the mobile phone which corresponds to the dialed number of the mobile phone whose terminating call will be picked up, instead of searching the terminating information DB 35 using the location information and group code of the pick-up requesting subscriber.

In the second preferred embodiment of the present invention, the terminating ringing information about mobile phones currently being called is registered and managed in the terminating information DB 35. DB 35 may be separately managed as a database rather than a common memory of processors constituting the terminating call processor 30, which common memory is shared by terminating processes of the relevant processor. Thus, a mobile communication subscriber located nearby within the audible area may request the call pick-up service even if he or she is not located within the coverage of the same base station or sector as the mobile phone which is currently being called.

For example, in the base station structure illustrated in FIG. 9, cells 1 to 5 may be considered as belonging to a base station controller different from the base station controller of cells 6 to 9. Here, mobile phone A requesting a call pick-up is located in cell 1, and mobile phones B, C, D, E, F, G, which have the same group code as the mobile phone A and are currently receiving terminating calls, are distributed as shown in FIG. 9. In this arrangement, if the picking up range is limited to the same base station, only mobile phone B or C can be the one for which the terminating call may be picked up.

Further, even if the terminating call picking up range is not limited to the same base station, because the terminating information memory that the terminating pick-up process for the pick-up requesting mobile phone A accesses registers and manages only mobile phones B and C of cell 1, mobile phone D of cell 2, and mobile phone F of cell 4 in the first preferred embodiment of the present invention. Mobile phone E of cell 7 is not registered in the above terminating information memory because mobile phone E is under the control of a different base station controller even though mobile phone E is adjacent to mobile phone A. Thus, mobile phone E is excluded from the group of mobile phones for which terminating calls may be picked up by mobile phone A in the first preferred embodiment of the present invention.

However, in the second preferred embodiment of the present invention, the terminating information DB 35 is implemented in a separate database space rather than in multiple terminating information memories which are managed only for the corresponding individual base station controllers, and the terminating ringing information is registered and managed in that terminating information DB 35. Thus, mobile phone E of cell 7 may also be included in mobile phones for which terminating calls may be picked up. Further, by limiting the mobile phones for which terminating calls may be picked up to mobile phones within the audible area where ringing signal may be heard (which is made possible by referring to the adjacent base station list DB 36), mobile phone F of cell 4, located outside of the audible area of mobile phone A which is currently requesting the call pick-up, is excluded from the mobile phones for which terminating calls may be picked up.

In other words, in the second preferred embodiment of the present invention, only mobile phones B and C of cell 1, mobile phone D of cell 2 and mobile phone E of cell 7, which are within the audible area of the pick-up requesting mobile phone A, are searched as mobile phones for which terminating calls may be picked up. Mobile phone F of cell 4 and mobile phone G of cell 8, which are located outside of the audible area of mobile phone A, are excluded from the mobile phones whose terminating calls may be picked up in the present invention. If, however, cell 4 is managed by an omni base station, mobile phone F of cell 4 will also be searched as a mobile phone whose terminating call may be picked up.

The call pick-up function in a mobile communication network according to the present invention may be applied to a wireless private switching system which performs the same functions as the mobile switching system. Here, the wireless private switching system is a system through which an individual mobile phone subscriber located in an area where the private wireless network service can be provided is registered as a user of an extension number and thus may use the private wireless network service and the public mobile network service at the same time.

If such wireless private switching system adopts the present invention, because the information about mobile phone subscribers located in the service area is stored and managed in the switching system's database, the database management system will take the role of the visitor location register described in the preferred embodiments of the present invention. Further, when a call pick-up request is made for a mobile phone within the service area of a private wireless network, the relevant pre-assigned extension number may be used for the call pick-up.

As explained above, the present invention registers and manages in a common memory the terminating ringing information of a mobile phones being called by a terminating process, enabling the terminating call at a certain mobile phone to be picked up by another mobile phone located within the coverage of the same base station or the same sector.

Because a terminating call arriving at a certain mobile phone may be picked up by another mobile phone for communication according to the present invention, it is made possible to answer a terminating call even if the relevant mobile phone is out of battery or may not be located while there is ringing for the terminating call, or even if the mobile phone is located too far to be reached by a person.

Further, because the present invention designates groups of subscribers who can pick up terminating calls for other subscribers and manages such groups, only a subscriber within the same group can pick up a terminating call arriving at a mobile phone and thus it is possible to prevent privacy infringement which may be caused by unchecked picking up of calls.

Moreover, by displaying on the mobile phone receiving the terminating call the number of the mobile phone which requests to pick up such terminating call, the present invention gives the absent subscriber notice of who picked up the terminating call instead of the absent subscriber.

On the other hand, according to the present invention, the terminating ringing information including numbers, location and terminating PID of the mobile phones receiving terminating calls in a mobile communication network is stored in a separate terminating information DB and is managed according to the relevant group codes and thus a terminating call directed to a mobile phone may be picked up for communication by another mobile phone within the area where the terminating call ringing signal may be heard regardless of whether such area is within the coverage of the same base station or the same sector.

Moreover, by classifying subscribers who can pick up terminating calls of other subscribers into groups and managing the area where ringing signal may be heard as adjacent base station list DB, the present invention allows only subscribers within the same group to pick up terminating calls for other subscribers in the same group and excludes terminating calls arriving at places out of the audible area from the calls to be picked up, for the purpose of providing an efficient call pick-up service.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A call pick-up system in a mobile communication network comprising:
a call processor that manages ringing information for a call directed to a first mobile phone, receives a call pick-up request for a second mobile phone, and connects the call to the second mobile phone;
a visitor location register that transmits to the call processor subscriber information about the second mobile phone which transmitted the call pick-up request; and
a base station controller that controls assignment of a wireless traffic channel in response to the call pick-up request, and controls connection or disconnection of a communication line to the first mobile phone.

2. The call pick-up system according to claim 1, wherein the call processor performs:
a terminating ringing process that manages the ringing information and transmits an originating PID and switch information corresponding to the call; and
a terminating pick-up process that sends call pick-up request information to the terminating ringing process, receives from the terminating ringing process the originating PID and switch information for the call, and notifies an originating process designated by the originating PID of the response to the call.

3. The call pick-up system according to claim 2, wherein the terminating ringing process terminates the call after receiving from the terminating pick-up process a number of the second mobile phone which transmitted the call pick-up request, displays the number, through the base station controller, on the first mobile phone for which the call is to be picked up, and deletes the ringing information.

4. The call pick-up system according to claim 2, wherein after receiving the subscriber information from the visitor location register, the terminating pick-up process searches a terminating information memory using location information and a group code included in the subscriber information and, as a result, obtains the terminating PID of the terminating ringing process.

5. The call pick-up system according to claim 4, wherein the first mobile phone is located within a coverage area of the same base station or sector as the second mobile phone and has a same group code as the second mobile phone.

6. The call pick-up system according to claim 4, wherein the call processor stores the ringing information including a number of the first mobile phone, location information represented by base station ID and/or sector ID, a terminating PID, and a pick-up group code.

7. A call pick-up system in a mobile communication network comprising:
an adjacent base station list DB that stores IDs of adjacent base stations and/or sectors belonging to an audible area where a ringing signal of a first mobile phone currently being called may be heard;
a terminating information DB that stores the terminating ringing information for the first mobile phone;
a terminating call processor that searches the adjacent base station list DB and the terminating information DB based on a pick-up group code and location information of a second mobile phone which transmitted a call pick-up request and then connects a terminating call for the first mobile phone to the second mobile phone;
a visitor location register that transmits to the terminating call processor subscriber information for the second mobile phone, the subscriber information including a group code and location information for the second mobile phone; and
a base station controller that controls assignment of wireless traffic channels in response to the call request and controls connection or disconnection of a communication line to the first mobile phone.

8. The call pick-up system according to claim 7, wherein the terminating call processor performs:
a terminating ringing process that manages the terminating ringing information about the first mobile phone in the terminating information DB and transmits an originating PID and switch information corresponding to the terminating call; and
a terminating pick-up process that searches the adjacent base station list DB and the terminating information DB upon receipt of the call pick-up request, sends the call pick-up request to the terminating ringing process designated by a terminating PID corresponding to a number for the terminating call belonging to a same pick-up group and located within the ringing signal audible area, receives from the terminating ringing process the originating PID and switch information for the terminating call, and then notifies an originating process designated by the originating PID of a response to the terminating call.

9. The call pick-up system according to claim 8, wherein the terminating ringing process terminates the terminating call after receiving from the terminating pick-up process a number of the second mobile phone which transmitted the call pick-up request and then transmits the number through the base station controller for display on the first mobile phone, and deletes the terminating ringing information.

10. The call pick-up system according to claim 8, wherein after receiving from the visitor location register the pick-up group code and location information of the second mobile terminal which transmitted the call pick-up request, the terminating pick-up process searches the adjacent base station list DB based on the received pick-up group code to obtain information about the base station and/or sector located within the audible area of the ringing first mobile phone, and searches the terminating information DB using the location information and information about the ringing signal audible area to obtain the terminating PID corresponding to the terminating call.

11. A call pick-up method in a mobile communication system, comprising:
registering in a terminating information memory ringing information corresponding to a first mobile phone, the ringing information including a number, group code, location information, and a PID of the first mobile phone;
if a call pick-up request for the first mobile phone is received from a second mobile phone, searching the ringing information in the terminating information memory using a group code and location information corresponding to the second mobile phone;
sending the call pick-up request to a terminating ringing process designated by a terminating PID corresponding to a call to be picked up within the same group and coverage area of the same base station or sector as the second mobile phone; and
notifying an originating process of a response to the call using an originating PID and switch information transmitted by the terminating ringing process as a response to the call pick-up request and, at the same time, connecting the communication line.

12. The call pick-up method according to claim 11, wherein the group code indicates whether the call may be picked up or not and identifies a relevant subscriber group where mobile communication subscribers are classified as a group of subscribers who can pick up terminating calls for other subscribers in the same group.

13. The call pick-up method according to claim 11, wherein the terminating PID is obtained by searching the terminating information memory using the group code and location information corresponding to the second mobile phone that transmitted the pick-up request, and is the terminating PID of the terminating ringing process which is processing the call for the first mobile phone belonging to the same group and located within the coverage of the same base station or sector as the second mobile phone.

14. The call pick-up method according to claim 11, further comprising:
confirming whether there is a response to the terminating ringing or a call pick-up request before a time-out period, by counting a terminating ringing time from when a terminating ringing process informed an originating process of a terminating ringing status of the relevant mobile phone; and
if there is a call pick-up request before the time-out period, terminating the call, releasing the registered terminating ringing information from the terminating information memory, and then transmitting to the terminating pick-up process the originating PID and switch information.

15. The call pick-up method according to claim 14, further comprising:
notifying the originating process of the response to the terminating call if it is determined that there has been a response to the terminating ringing before the terminating ringing time-out from the mobile phone at the terminating side.

16. The call pick-up method according to claim 14, further comprising:
notifying the originating process of the call failure caused by absence of any response and terminating the call if it is determined that there has been neither a response to the terminating ringing nor a call pick-up request before the terminating ringing time-out.

17. The call pick-up method according to claim 11, further comprising:
interpreting a terminating number in the originating request message and confirming the call pick-up request; and
receiving from a visitor location register subscriber information including a group code and location information relating to the second mobile phone which transmitted the call pick-up request.

18. The call pick-up method according to claim 17, further comprising:
confirming whether a call pick-up request has been transmitted from the second mobile phone and recognizing that the call pick-up request was transmitted if interpretation of the terminating number included in an originating request message starts with specific digits indicating a call pick-up request.

19. The call pick-up method according to claim 18, further comprising:
if the interpretation of the terminating number confirms that the call pick-up request was transmitted:
searching the terminating information memory using the number of the first mobile phone; and
sending a call pick-up request to the terminating ringing process designated by the terminating PID corresponding to the number of the first mobile phone stored in the terminating information memory.

20. The call pick-up method according to claim 11, further comprising:
displaying the number of the second mobile phone on the first mobile phone, if the number of the second mobile phone is received from the terminating pick-up process at the time of making a call pick-up request.

21. The call pick-up method according to claim 11, further comprising:
at the originating process which received notice of the response to the call from the terminating pick-up process, renewing the terminating PID information which has been stored in a call register with the terminating PID of the terminating pick-up process, while making transition to a busy state.

22. A call pick-up method in a mobile communication network, comprising:
registering in a terminating information DB terminating ringing information including a number, location information, and PID of a first mobile phone receiving a call and relevant PIDs according to relevant pick-up groups;
if there is a call pick-up request from a mobile phone, searching an adjacent base station list DB and the terminating ringing information in the terminating information DB using a group code and location information of the mobile phone transmitting the pick-up request;
sending the call pick-up request to a terminating ringing process designated by a terminating PID corresponding to the terminating call to be picked up, belonging to the same group as the mobile phone transmitting the pick-up request and located within a ringing signal audible area; and
notifying an originating process of a response to the terminating call using an originating PID and switch information transmitted by the terminating ringing process as a response to the call pick-up request and, at the same time, connecting the communication line.

23. The call pick-up method according to claim 22, further comprising:
transmitting the originating PID and switch information to the terminating pick-up process after terminating the terminating call for which the call pick-up request has been made and after releasing the registered terminating ringing information from the terminating information DB.

24. The call pick-up method according to claim 21, wherein said sending of a call pick-up request to the terminating ringing process comprises:
searching the adjacent base station list DB using a pick-up group code of the mobile phone transmitting the call pick-up request to obtain information on the base stations and/or sectors located within the ringing signal audible area;
searching the terminating information DB using the location information of the mobile phone transmitting the call pick-up request and the obtained information about the ringing signal audible area to obtain the terminating number for which the call pick-up can be performed; and
sending a call pick-up request for the mobile phone currently being called to the terminating ringing process designated by the terminating PID corresponding to the obtained terminating number for which the call pick-up can be performed.

25. The call pick-up method according to claim 24, wherein the adjacent base station list DB stores, for each base station sector, IDs of adjacent base stations and/or sectors located within the audible area where a ringing signal of the mobile phone may be heard.

26. The call pick-up method according to claim 22, further comprising if mobile phones within the pick-up group support a GPS function:
receiving from the base station controller GPS location information about the mobile phone transmitting the pick-up request;
searching the terminating ringing information registered in the terminating information DB using the pick-up group code of the mobile phone transmitting the pick-up request and the received GPS location information; and
sending a call pick-up request to the terminating ringing process designated by a terminating PID corresponding to a terminating number for which the terminating pick-up can be performed, belonging to the same pick-up group and located within the ringing signal audible area.

27. A method for processing calls in a mobile communication system, comprising:
receiving a request to pick up a call directed to a first mobile terminal; and
transferring the call to a second mobile terminal in response to the request.

28. The method of claim 27, wherein the first and second mobile terminals are located in a coverage area of a same base station or sector.

29. The method of claim 27, wherein the first and second mobile terminals are located in coverage areas of different base stations or sectors.

30. The method of claim 27, further comprising:
transmitting information to the first mobile terminal indicating a number of the second mobile terminal that received the transferred call.

31. The method of claim 27, further comprising:
storing information indicative a group of mobile phones eligible to pick-up calls for the first mobile phone; and
determining whether the second mobile phone is in said group, wherein said transferring step is performed only if the second mobile phone is determined to be within said group.

32. A system for processing calls in a mobile communication system, comprising:
a processor which receives a request to pick up a call directed to a first mobile terminal and transfers the call to a second mobile terminal in response to the request.

33. The system of claim 32, wherein the first and second mobile terminals are located in a coverage area of a same base station or sector.

34. The system of claim 32, wherein the first and second mobile terminals are located in coverage areas of different base stations or sectors.

35. The system of claim 32, wherein the processor transmits information to the first mobile terminal indicating a number of the second mobile terminal that received the transferred call.

36. The system of claim 32, further comprising:
a storage unit which stores information indicative a group of mobile phones eligible to pick-up calls for the first mobile phone, wherein the processor determines whether the second mobile phone is in said group and then transfers the call to the second mobile only if the second mobile phone is determined to be within said group.

37. A mobile terminal, comprising:
a receiver that receives a call signal; and
a processor which displays information identifying another mobile terminal which picked up a call corresponding to the call signal.

38. The mobile terminal of claim 37, wherein said information is a number of the mobile terminal.
